(19) United States
(12) Patent Application Publication
(10) Pub. No.: US 2005/0057391 A1
(43) Pub. Date: Mar. 17, 2005

(54) Method to improve interferometric signatures by coherent point scatterers

(76) Inventors: Lawrence Parker Galloway Forsley, Annandale, VA (US); Charles Lincoln Werner, Tagertschl (CH); Urs Wegmuller, Rubigan (CH)

Correspondence Address: Lawrence P.G. Forsley, P.O. Box 1261, Annandale, VA, 22003, US

(21) Appl. No.: 10/894,276

(22) Filed: Jul. 19, 2004

Related U.S. Application Data
(60) Provisional application No. 60/488,687, filed on Jul. 19, 2003.

(51) Int. Cl. G01S 13/90

(52) U.S. Cl. 342/25 A; 342/25 C; 342/25 F; 342/191

(57) ABSTRACT

A method that exploits the temporal, spatial and spectral characteristics of interferometric signatures collected from coherent point scatterers appearing in stacked Synthetic Aperture Radar frames. These points are bootstrapped by iteratively re-apportioning atmospheric and topographic phase contributions and refining the satellite ephemeris and the point height. Model results specific to coherent point scatterers are then extrapolated to surrounding areas. Measurements of deformation rates in the sub mm/year range and height differentials in the sub meter range are possible. Geo-spatially located coherent point scatterers are maintained in a database for correlation with other geo-spatial information.

### BACKGROUND OF INVENTION

DIFFERENTIAL SAR INTERFEROMETRY

In recent years, space-borne repeat-pass differential SAR interferometry, see FIG. 8, has demonstrated a good potential for displacement mapping with mm resolution as noted by U. Wegmüller et al,[U. Wegmüller T. Strozzi, and C. Wemer, “Characterization of Differential Interferometry Approaches” European Conference on Synthetic Aperture Radar, EUSAR'98, Friedrichshafen, Germany, 25-27 May 1998] and Rosen [P. Rosen et al., “Synthetic Aperture Radar Interferometry,” Proc. IEEE Vol. 88, No. 3, pp. 333-382, 2000]. Applications exist in the mapping of seismic and volcanic surface displacement as well as in land subsidence and glacier motion.

The interferometric phase is sensitive to both surface topography and coherent displacement along the look vector occurring between the acquisitions of the interferometric image pair. Inhomogeneous propagation delay (“atmospheric disturbance”) and phase noise are the main error sources. The basic idea of differential interferometric processing is to separate the topography and displacement related phase terms. Subtraction of the topography related phase leads to a displacement map. In the so-called 2-pass differential interferometry approach the topographic phase component is calculated from a conventional Digital Elevation Model (DEM). In the 3-pass and 4-pass approaches the topographic phase is estimated from an independent interferometric pair without differential phase component. In practice, the selection of one of these approaches for the differential interferometric processing depends on the data availability and the presence of phase unwrapping problems, which may arise for rugged terrain.

In the case of stationary motion the displacement term may be subtracted to derive the surface topography. A typical application of this technique is the mapping of the surface topography of glaciers.

The unwrapped phase φ_{unw} of an interferogram can be expressed as a sum of a topography related term φₜₒₚₒ, a displacement term φ_{disp}, a path delay term φₚₐₜₕ, and a phase noise (or decorrelation) term φₙₒᵢₛₑ:
φ_{unw}=φₜₒₚₒ+φ_{disp}+φₚₐₜₕ+φₙₒᵢₛₑ (1)
The baseline geometry and φₜₒₚₒ allow the calculation of the exact look angle and, together with the orbit information, the 3-dimensional position of the scatter elements (and thereby the surface topography).

The displacement term, φ_{disp}, is related to the coherent displacement of the scattering centers along the radar look vector, r_{disp}:
φ_{disp}=2kr_{disp} (2)
where k is the wavenumber. Here coherent means that the same displacement is observed of adjacent scatter elements.

Changes in the effective path length between the SAR and the surface elements as a result of changing permittivity of the atmosphere, caused by changes in the atmospheric conditions (mainly water vapor), lead to non-zero φₚₐₜₕ.

Finally, random (or incoherent) displacement of the scattering centers as well as noise introduced by SAR signal noise is the source of φₙₒᵢₛₑ. The standard deviation of the phase noise σφ (reached asymptotically for large number of looks N) is a function of the degree of coherence, γ[1],

$${σ}_{ϕ} = \frac{1}{2 N} \frac{\sqrt{1 - {γ}^{2}}}{γ} . \qquad ( 3 )$$

Multi-looking and filtering reduce phase noise. The main problem of high phase noise is not so much the statistical error introduced in the estimation of φₜₒₚₒ and φ_{disp} but the problems it causes with the unwrapping of the wrapped interferometric phase. Ideally, the phase noise and the phase difference between adjacent pixels are both much smaller than τ. In reality this is often not the case, especially for areas with a low degree of coherence combined with rugged topography, as present in the case of forested slopes.

Assuming that there is no surface displacement, i.e. φ_{disp}=0, allows relating φ_{unw} to surface topography, with φₙₒᵢₛₑ introducing a statistical error and φₚₐₜₕ introducing a non-statistical error. In a similar way assuming that φₜₒₚₒ=0 allows to interpret φ_{unw} as φ_{disp} which can be related to coherent surface displacement along the look vector, again with φₙₒᵢₛₑ introducing a statistical error and φₚₐₜₕ introducing a non-statistical error. It is important to keep in mind that the topography related phase term gets small not only for negligible surface topography but also for very small B_{⊥} due to its indirect proportionality with the baseline component perpendicular to the look vector B_{⊥},

The main objective of differential interferometry is the isolation of the surface topography and the surface displacement contributions to the unwrapped interferometric phase, including all the more general cases with φ_{disp}≠0 and φₜₒₚₒ≠0.

The relation between a change in the topographic height σₕ and the corresponding changes in the interferometric phase σ_{φ} is given by,

$${σ}_{h} = \frac{{λ}_{{r}_{1}} sin θ}{4 π {B}_{⊥}} {σ}_{ϕ} . \qquad ( 4 )$$

For the ERS-1 and ERS-2 SAR sensors, with a wavelength is 5.66 cm, a nominal incidence angle of 23 degrees, and a nominal slant range of 853 km Equation (4) reduces to

$${σ}_{h} \approx 1500 \frac{{σ}_{ϕ}}{{B}_{⊥} [ m ]} , \qquad ( 5 )$$

allowing us to estimate the effect of the topography.

So far we assumed that all of the phase terms are available in their unwrapped form. It may be that only the wrapped interferometric phase W[φ_{unw}] is known. The topographic phase term may be estimated either based upon a digital elevation model (DEM) or an independent interferogram without displacement. The derivation, based on a DEM, allows us to directly estimate the unwrapped topographic phase term φ_{topo,est}. The estimation from an independent interferogram starts from its wrapped interferometric phase. Here we can further distinguish between two cases based on the criteria if we succeed in unwrapping this wrapped phase. For the estimation of the topographic phase term of the reference interferogram 1, φ_{1,topo,est}, the topographic phase term of the interferogram 2, φ_{2,topo}, needs to be scaled by the ratio between the perpendicular baseline components

$${ϕ}_{1 , topo , est} = {ϕ}_{offset} + \frac{{B}_{1 ⊥}}{{B2}_{⊥}} {ϕ}_{2 , topo} \qquad ( 6 )$$

In general the ratio B_{1⊥}/B_{2⊥}, is not an integer and therefore the precise scaling cannot be done without phase unwrapping. In cases where neither a DEM is available nor phase unwrapping of the topographic reference interferogram was successful the scaling of the wrapped phase images with integer factors may provide the best result. For B_{1⊥}=100 m and B_{2⊥}=183 m, for example, the wrapped differential interferogram calculated as
W[φ_{diff}]=W[2·W[φ₁]−W[φ₂]] (7)
contains twice the displacement phase term but just a very small topographic phase term corresponding to a baseline of −17 m. It has to be kept in mind though, that the scaling will also scale the phase noise.

It is significant to realize that relative displacements may be accurately computed even when the absolute displacement is either unknown, because of an inability to construct a baseline, or poorly known because of a lack of references.

Several patents have been granted over the past 10 years showing a steady understanding of the problems of repeat pass differential interferometry and methods to compensate for various phase error contributions, see Gabriel, et al. [U.S. Pat. No. 4,975,704, Gabriel and Goldstein, “Method for detecting surface motions and mapping small terrestrial or planetary surface deformations with synthetic aperture radar”]; or Feretti, et al. [U.S. Pat. No. 6,583,751, Feretti, et al, “Process for radar measurements of the movement of city areas and landsliding zones”].

Previous work has concentrated on the intensity, or brightness, of the presumed permanent or persistent scatterers. This fails where the intensity is a poor measure of quality. Others compute differential interferograms of all of the points in the scene, as opposed to only those points having high coherence. If the interferograms are wrapped, an eventual unwrapping error will occur since most of the points are not of high quality, and processing will fail.

Feretti, et al, [Feretti et al, “Nonlinear Subsidence Rate Estimation Using Permanent Scatterers in Differential SAR Interferometry” IEEE TRANSACTIONS ON GEOSCIENCE AND REMOTE SENSING, VOL. 38, NO. 5, SEPTEMBER 2000] compute a stack of interferograms with 1 master and n-1 slaves, and then perform a regression of the differential phase at each of the points fitted with a polynomial model. This fails, as the authors note, where there is non-linear deformation, which is often what is of greatest interest. In addition, the high computational requirements for computing raster interferograms for every point in the image, and the difficulties of distinguishing among the various contributors to phase delay, along with the uncertainty due to atmosphere at large distances from a reference point have held the size of the images to relatively small, 5 km×5 kin sized urban environments filled with man-made scatterers.

### SUMMARY OF INVENTION

The primary object of the invention is to create a map of linear deformation rate more accurate than 1 mm/year in the satellite line of sight.

Another object of the invention to provide a non-linear deformation map accurate to better than 1 mm in the satellite line of sight.

Another object of the invention is to provide a map of tropospheric water vapor density.

Another object of the invention is to provide a geo-spatially encoded coherent point scatterer list stored in a data base.

Another object of the invention is to cross-correlate the coherent point scatterer geo-coded database with other geo-spatial information.

Another object of the invention is evaluate interferometric signatures of the geo-coded coherent point scatterers from the same and adjacent coherent points taken under different conditions.

Another object of the invention is to operate over large areas (>20km×20 km).

Another object of the invention is to spectrally identify those permanent, persistent, stable or coherent points that exhibit a high degree of spectral coherence.

The means to determine the spectral coherence is to examine the speckle characteristics of all the points and assign a statistical measure to every pixel in the SLC. This measure is averaged over the stack of SLCs (3 or more) and the value is thresholded. All points that remain point like will have a higher average measure, specular coherence, relative to other points. Points are identified by 2D FFT Power spectrum to determine:
1. angular independence of the target phase
2. range frequency independence of the target phase (equivalent to incidence angle independence)

Those points passing the threshold are used to calculate differential interferograms on a point by point basis. Polynomial and non-polynomial models are used to fit the differential interferogram at the points and are used to estimate deformation.

Another object of the invention is to model atmosphere by identifying phase contributions that are both temporally uncorrellated and spatially correlated, where the filter works in the following way:
1. spatially filter the residual phase after subtraction of the height related phase and the phase due to linear deformation rate
2. unwrap the phase and select a common reference point for the entire stack
3. Temporally low pass filter using a moving weighted average.
4. Subtract this from the original phase to get the high pass temporally uncorrelated component

Another object of the invention is to use a single reference frame when there are more than 10 radar images and the single reference frame is selected on the basis of minimizing the baselines with other frames in the series and is in the middle of the time series.

Another object of the invention is to use a multiple reference frame when there are 10 or fewer radar images and each pair with acceptable baselines and temporal duration are used to produce a corrected height map that then allows single reference point based deformation maps to be produced.

Another object of the invention is to bootstrap the identification and qualification of coherent point scatterers as shown in FIG. 1 where:

FIG. 1.1 refers to the initial data load including the resampled single look complex images, an initial height map (flat, if no Digital Elevation Map is available) and a table of interferometric pairs, itab.

FIG. 1.2 refers to the generation of the initial point list and a point mask for leaving some point out.

FIG. 1.3 refers to the processing of the Single Look Complex image using the derived point lists.

FIG. 1.4 refers to the generation of point based differential interferograms derived from the SLCs and the point lists resulting in differential heights, dh, differential deformation, ddef, the quality of the point, sigma, the differential unwrapped phase, the residual phase, and the use of a point mask.

FIG. 1.5 refers to the model refinement and results in a new generation of the heights, deformation, atmospheric phase component, residual atmosphere, which also contains non-linear deformation and the point mask. The step-wise refinement, or bootstrapping, at this stage may cause a new round of differential interferograms to be calculated, or a refinement of the baselines or the generation of a new point list; whereupon, the refinement continues to reapportion the phase contributions noted in Equation 1, shown again here:
φ_{unw}=φₜₒₚₒ+φ_{disp}+φₚₐₜₕ+φₙₒᵢₛₑ (1)

Where these terms refer to the phase and the unwrapped phase consists of topographic, displacement, path length and noise terms.

### BRIEF DESCRIPTION OF DRAWINGS

The drawings constitute a part of this specification and include exemplary embodiments to the invention, which may be embodied in various forms. It is to be understood that in some instances various aspects of the invention may be shown exaggerated or enlarged to facilitate an understanding of the invention.

FIG. 1 shows the fundamental Coherent Point Scatterer bootstrap process.

FIG. 2 illustrates JERS Baselines used in FIG. 3.

FIG. 3 shows the Interferometric Phase and Phase vs. Time over Kioga, Japan.

FIG. 4 shows the Coherent Point Scatterer Elements over Kioga, Japan

FIG. 5 presents the CPS registered image of Kioga, Japan.

FIG. 6 displays the Baseline Ambiguity In the JERS Orbital State Vector, that can be corrected.

FIG. 7 show the monitoring of a Single Coherent Point Scatterer, resulting in a “Breathing Building” in Pasadena, Calif.

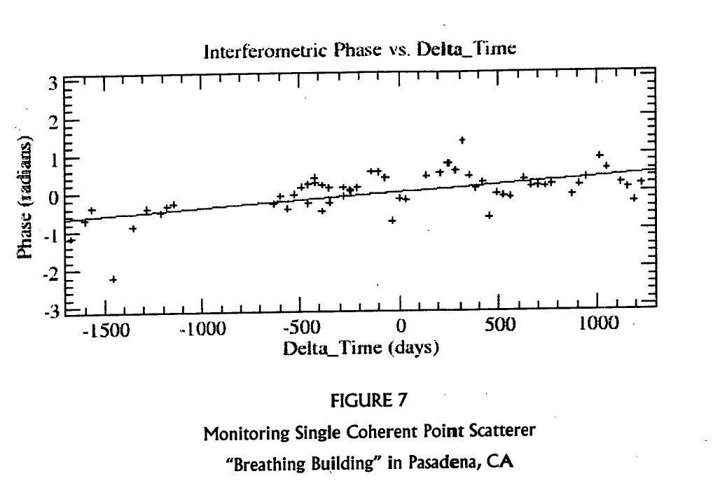

FIG. 8 Illustrates Radar from Space.

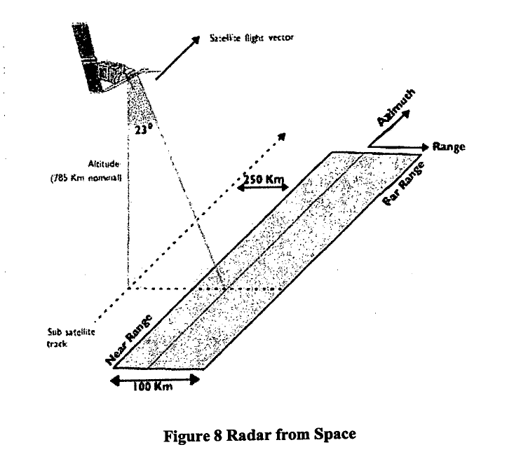

FIG. 9 shows the London height corrected DEM.

FIG. 10 displays subterranean activity in London, England.

FIG. 11 shows the Ranked Deformation of subsidence in London, England.

FIG. 12 shows the Ranked Deformation Rates in the entire London region, 30 km×35 km.

FIG. 13 indicates Jubilee Line Specific Ranked Deformation Rates—Region 3 km×10 km

FIG. 14 shows deforming points within 500 meters of the tube stations.

FIG. 15 indicates the deformation at Westminster Station in London.

FIG. 16 shows the Westminster Maximum Deformation.

FIG. 17 displays Deformation time sequences, 2 years apart, at Waterloo Station London, England.

### DETAILED DESCRIPTION OF THE PREFERRED EMBODIMENT

In this detailed description, unless otherwise indicated, the terms used throughout to describe the structure and operation of the invention will be consistent with the definitions and usage of such terms as would be known to one skilled in the art such as used and defined in Rosen [Rosen P., et al., “Synthetic Aperture Radar Interferometry,” Proc. IEEE Vol. 88, No. 3, pp. 333-382, 2000] which is incorporated herein by reference.

Coherent Point Scatterers

Coherent Point Scatterers is a method that exploits the temporal, spatial and spectral characteristics of interferometric signatures collected from stable scatterers that exhibit long-term coherence to map surface deformation. Use of the interferometric phase from long time series of data requires that the correlation remain high over the observation period. Ferratti et al. proposed interpretation of the phases of stable point-like reflectors [Ferratti A., C. Pratti, and F. Rocca, Non-linear subsidence rate estimation using permanent scatterers in differential SAR interferometry, IEEE TGRS, Vol.38, No. 5, pp. 2202-2212, September 2000. and Ferretti A., C. Pratti, and F. Rocca, Permanent scatterers in SAR interferometry, IEEE TGRS Vol 39, No. 1, pp. 8-20, January 2001.] Use of the phase from these targets has several advantages compared with distributed targets including lack of geometric decorrelation and high phase stability.

CPS Processing Approach

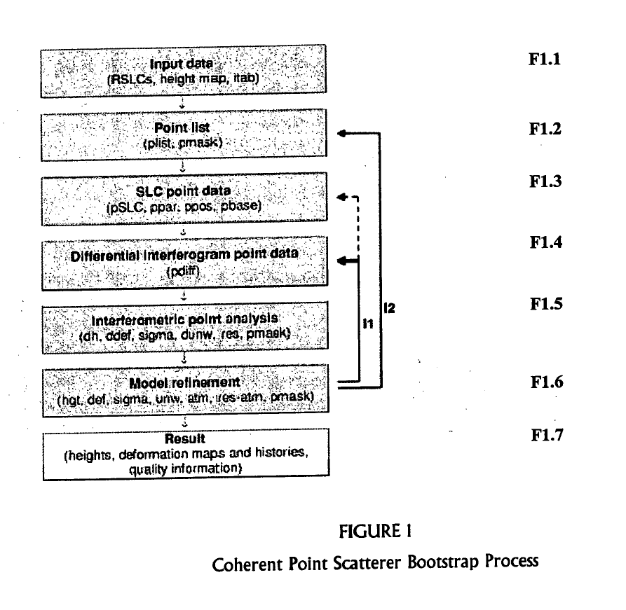

FIG. 1 shows how processing begins by assembling a set of Synthetic Aperture Radar (SAR) data acquisitions covering the time period of interest. Having as many acquisitions as possible leads to improved temporal resolution of non-linear deformation. The image stack is processed to single look complex (SLC) images and co-registered to a common geometry. An initial set of candidate point targets is then selected. Points suitable for CPS exhibit stable phase and a single scatterer dominates the backscatter within the resolution element. A phase model consisting of topographic, deformation and atmospheric terms is subtracted from the interferograms to generate a set of point differential interferograms as noted by Werner, et al. [C. L. Werner et al, “Interferometric Point Target Analysis for Deformation Mapping,” IGARSS'03 Proceedings, Toulouse, France, 2003].

The topographic component of the phase model is obtained by transforming the DEM into radar co-ordinates using baselines derived from the orbit state vectors. If no DEM is available, it is still possible to perform the analysis by initially assuming a flat surface. Processing proceeds by performing a 2D least-squares regression on the differential phases to estimate height and deformation rate. The estimates are relative to a reference point in the scene. Residual differences between the observations and modeled phase consist of phases proportional to variable propagation delay in the atmosphere, non-linear deformation, and baseline-related errors. The interferometric baseline can also be improved using height corrections and unwrapped phase values derived from CPS. Spatial and temporal filtering is used to discriminate between atmospheric and non-linear deformation phase contributions. The atmosphere is uncorrelated in time, whereas the deformation is correlated. The CPS process can be iterated to improve both the phase model and estimates of deformation by using the initial estimates of atmosphere phase, deformation, heights, and baselines.

The step-wise iterative process begins with a pair-wise interferometric correlation of near neighbors, avoids unwrapping the phase, or estimating the atmosphere, to find an initial set of stable points since the atmospheric phase distortions are much reduced over short distances. These pair-wise correlated points are used as the basis to find more points increasing the set of local reference points, again using neighborliness to suppress atmospheric noise. Then these points are used to estimate the atmospheric phase contribution, and the process iterates again picking up additional reference points and further estimating and then removing the atmospheric contribution. By these means, we “bootstrap” our self toward an atmospheric corrected image by successive iterations and pair-wise correlations of nearest neighbors in the image starting from an initial 20 coherent point scatterers/km2 to 100 scatterers/km2. By this process we will end up with an absolute vertical height of between 0.5 and 1 meter, but, we can see linear deformation good to <1 mm/year. Having carried out this procedure, we then use patches to unwrap the phase, and because of the coherent point scatterers, we don't have to exhaustively search the image for reference points.

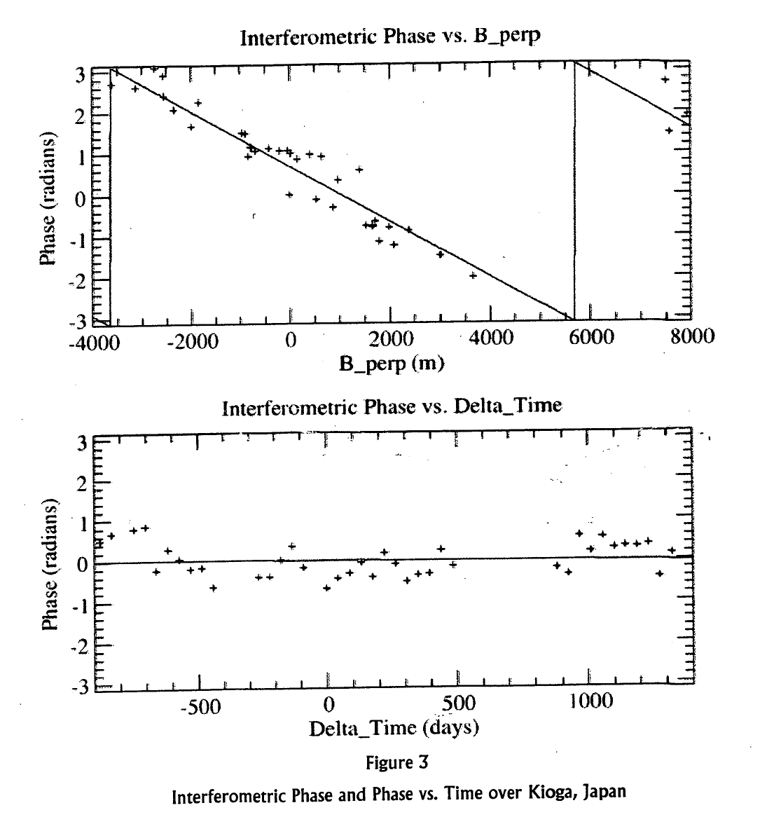

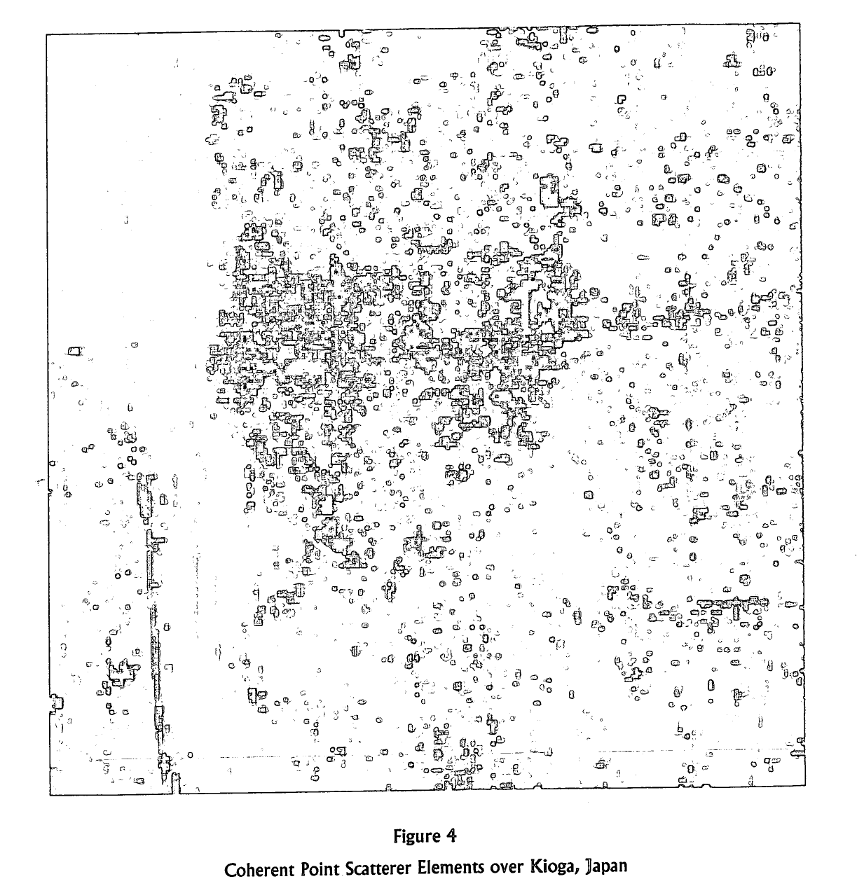

Essential for CPS processing is that there are enough point targets in the scene. Scattering is dominated by features on the scale of the wavelength or larger. From this aspect, there should at least be as many point scatterers for ERS as JERS. In general, higher resolution should lead to more point targets, independent of frequency. For the JERS data, point target candidates were selected using variability of the backscatter as a selection criterion. The standard deviation of the residual phase is then used later on as the measure of the point quality. In FIG. 3 is shown the phase regression for a point pair prior to inclusion of the atmospheric phase in the CPS phase model. This regression was then performed over the entire set of point candidates. Of these points 38360 were found to have a residual phase standard deviation <1.2 radians. In FIG. 4 is shown a small section of the multilook image of Koga with the point targets highlighted. This verifies that there are sufficient point targets within the urban scene for CPS analysis. The number of targets found is on the same order (1 00/sq. km) as for ERS for a similar urbanized region as noted by Werner [C. L. Werner et al, “Interferometric Point Target Analysis for Deformation Mapping,” IGARSS'03 Proceedings, Toulouse, France, 2003].

Patching

Patches are small areas with a local reference. The further from a given reference, the noisier the phase due to atmosphere. If the interferograms are unwrapped, then that phase noise causes increased uncertainty in the relative height and deformation. By patching the data, we are able to move out from the reference point. Once the scene has been unwrapped a single reference point for the entire frame, as large as the native radar image, which his 100 km×100 km, can be used. This then removes any “patch boundaries” that remain as artifacts due to ambiguities in the relative heights of the local reference points.

Simultaneous Solution of Height Error and Deformation Rate

By measuring just the relative phases between points allows the simultaneous solution of height error and deformation rate. These differences are integrated to get the global height correction and estimate and deformation. The patching is just a primitive way to do the integration. An alternative method is the simultaneous least-squares estimate over all the arcs amongst all points where the points constitute a network of points. The point network is then triangulated and measuring the estimates on the arcs are measured, and then integrating by least squares estimation for the height and deformation fore each point in the mesh.

Filtering

When we have our initial estimates of the height correction and deformation, then the residual phase is the sum of atmosphere, and non-linear deformation. We differentiate between deformation and atmosphere by noting that atmosphere is temporally uncorrelated and somewhat spatially correlated. We filter the residual phase to preserve that which has the characteristics of atmosphere. Of course if the deformation looks like atmosphere, you cannot distinguish between the effects. But generally deformation is temporally correlated. Apriori knowledge can allow the use of non-polynomial, or discontinuous functions in performing the least squares fit.

The filtering proceeds in the following stages:
1. spatially filter the residual phase after subtraction of the height related phase and the phase due to linear deformation rate.
2. unwrap the phase and select a common reference point for the entire stack
3. Temporally low pass filter using a moving weighted average.
4. Subtract this from the original phase to get the high pass temporally uncorrelated component
   Single Reference

When the image stack consists of 11 or more images, a Single Reference calculation is performed whereby a common reference is interfered with the other images in the stack. This image is selected to be relatively in the middle of the time series, so as to maintain as high temporal coherence as possible while simultaneously, choosing a common reference that minimizes perpendicular baselines between the pairs. After removing atmosphere and linear deformation, the resulting image shows deformation, by dividing by the time intervals, a deformation rate map is produced.

Multiple Reference

When the image stack consists of 10 or fewer images, all possible image pairs are interfered where temporal correlation is high and the perpendicular baseline is less than the critical perpendicular baseline. The phase in each image is spatially unwrapped. A least squares fit is performed and an improved height map is produced. This height map then allows Single Reference processing of an abbreviated image frame stack.

Baseline Quality

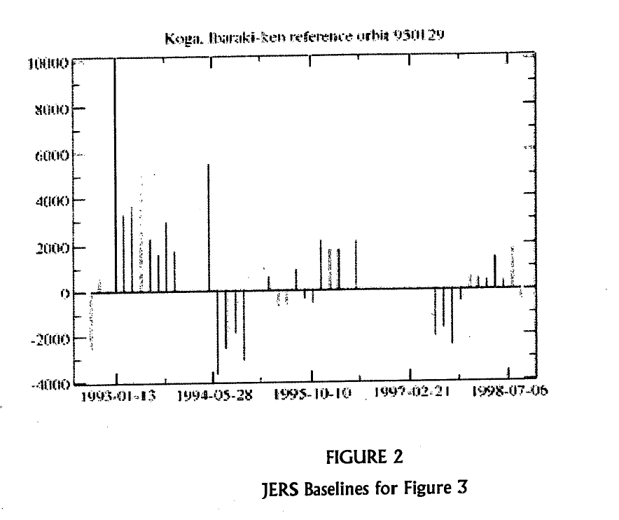

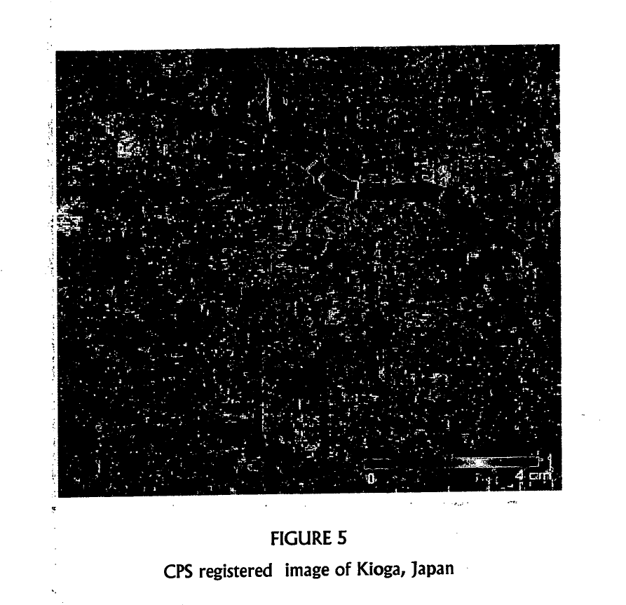

For JERS-1, the critical perpendicular baseline [symbol] B is approximately 6 km compared to the ERS value of 1.06 km. Spatial phase unwrapping of an interferogram is difficult for values of [symbol] B >25% of the critical value. Most of the acquisitions have baselines that exceed 25% of [symbol] B and therefore are excluded from standard 2-D differential interferometric analysis. The spread of the JERS baselines is similar to the ERS case considering the larger value of the critical baseline for JERS-1. FIG. 2 shows actual perpendicular baselines for JERS-1 for the scene shown in FIG. 5.

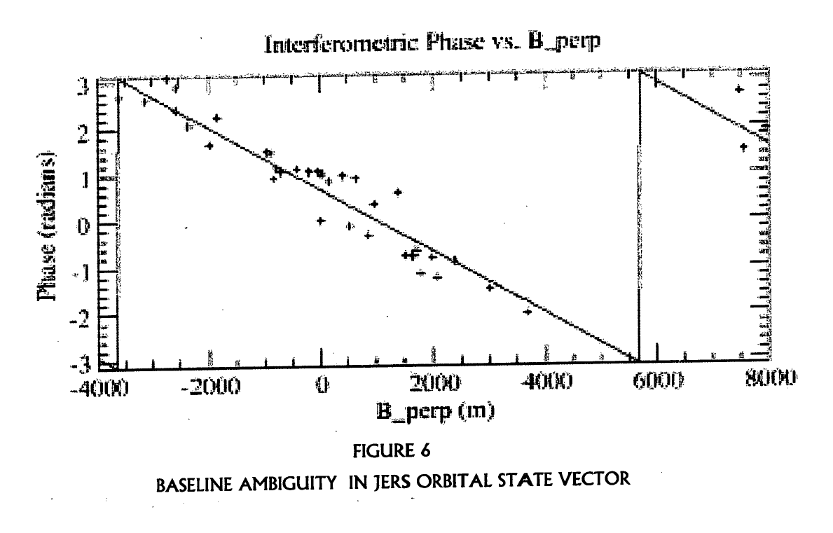

Estimates of the ERS baselines have sufficient accuracy for the initial CPS iteration because the ERS precision state vectors have sub-meter accuracy. Baseline errors for JERS-1 can be hundreds of meters when obtained from the orbit state vectors. These baseline errors cause phase ramps, as shown in FIG. 6, in the differential interferograms. Estimates of the residual fringe rate in the individual interferograms are used to refine the baselines, thereby improving the CPS phase model.

Essential for CPS processing is that there are enough point targets in the scene. Scattering is dominated by features on the scale of the wavelength or larger. From this aspect, there should at least be as many point scatterers for ERS as JERS. In general, higher resolution should lead to more point targets, independent of frequency. For the JERS data, point target candidates were selected using variability of the backscatter as a selection criterion. The standard deviation of the residual phase is then used later on as the measure of the point quality. In FIG. 3 is shown the phase regression for a point pair prior to inclusion of the atmospheric phase in the CPS phase model. This regression was then performed over the entire set of point candidates. Of these points 38360 were found to have a residual phase standard deviation <1.2 radians. In FIG. 4 is shown a small section of the multilook image of Koga with the point targets highlighted. This verifies that there are sufficient point targets within the urban scene for CPS analysis. Werner, et al, have noted that the number of targets found is on the same order (100/sq. km) as for ERS for a similar urbanized region [C. L. Werner et al, “Interferometric Point Target Analysis for Deformation Mapping,” IGARSS'03 Proceedings, Toulouse, France, 2003].

CPS Elements

CPS elements are maintained as lists of tuples greatly reducing the amount of data required for processing from over 300 megabytes/frame to on the order of 20 megabytes/frame. These tuples contain properties of the CPS element and allow re-registration with the frame. They also allow generation of derived properties. Derived properties include temporally varying velocity gradients and acceleration gradient maps, as well as further signature analysis characterizing atmospheric and topographic variations, and relating these to related signatures.

CPS elements are applied in a patch growing method which allows the maximum information available locally to be applied globally. As patches are grown together border discontinuities are resolved. Similarly, unwrapped phase ambiguities can be resolved in an automated fashion by iterating through adjacent previously unwrapped, unambiguous patches. By operating on CPS elements in patches, the distance to the local reference point is minimized. By minimizing this distance, local atmospheric effects are reduced.

Phase Sensitivity

The sensitivity of phase to deformation is directly proportional to the radar frequency. Therefore the phase for JERS is 0.24 of the ERS value for an equivalent LOS deformation. The variable path delay due to tropospheric water vapor is approximately independent of frequency, as noted by Goldstein [R. M. Goldstein, “Atmospheric limitations to repeat-track radar interferometry, Geophy. Res. Lett. Vol. 22, pp. 2517-2520, 1995]. For JERS-1, the ionosphere can contribute significant variations in path delay especially in Polar Regions as noted by Gray and Mattar [Gray, A. L, and K. Mattar “Influence of Ionospheric Electron Density Fluctuations on Satellite Radar Interferometry;” Geophysical Research Letters, Vol. 27, No 10, pp. 1451-1454, 2000.] L-band and C-band data are expected to have similar performance for measurement of deformation in areas where the phase residuals are dominated by variable atmospheric delay.

Spectral Sensitivity

We use the spectral shift to further quantify those points that remain with high coherence despite different perpendicular baseline. The invention takes the average of the specularity measure over all scenes, if a point is a point in one and all, then it will average to a high value, then threshold the specularity measures. The higher the measure, the more point like and stable the coherent point scatterer is.

Height Corrected DEM

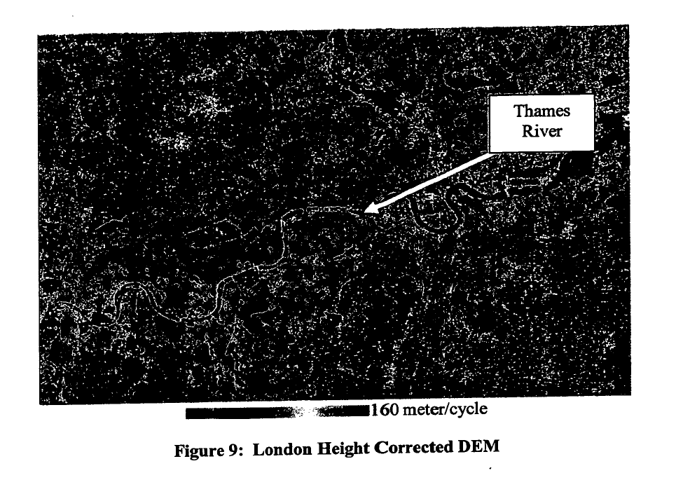

FIG. 9 shows a height corrected DEM for London, England. The DEM was derived from 27 SLC images taken over between 1992 and 2000. It has cm accuracy.

Non-Linear Deformation

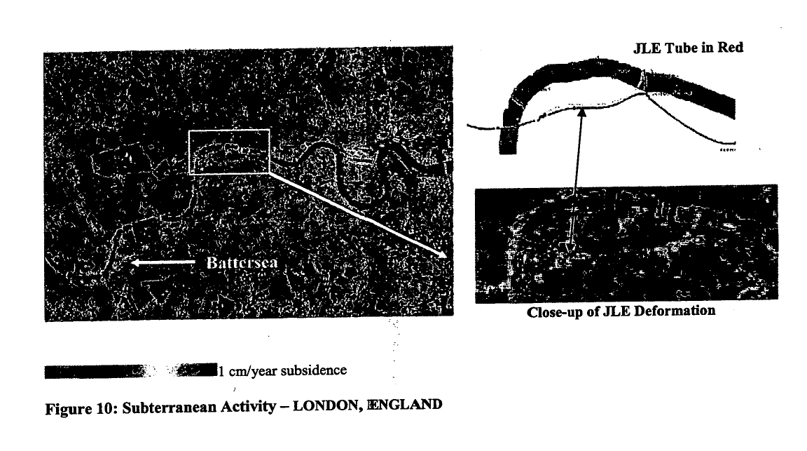

FIG. 10 shows a non-linear deformation map covering 1 cm/year subsidence. It includes a closeup of the deformation associated with the Jubilee Line Extension of the London Underground that began in 1991 and was fully operational in was operational in December, 1999. The map indicating the JLE Tube in Red shows the degree to which the deformation accurately follows the subway.

Database

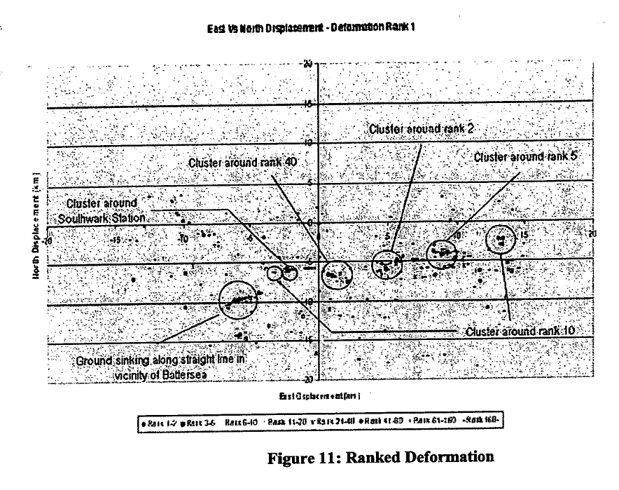

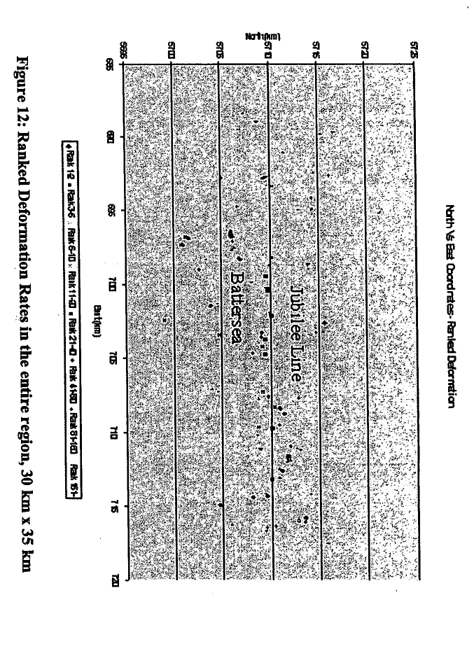

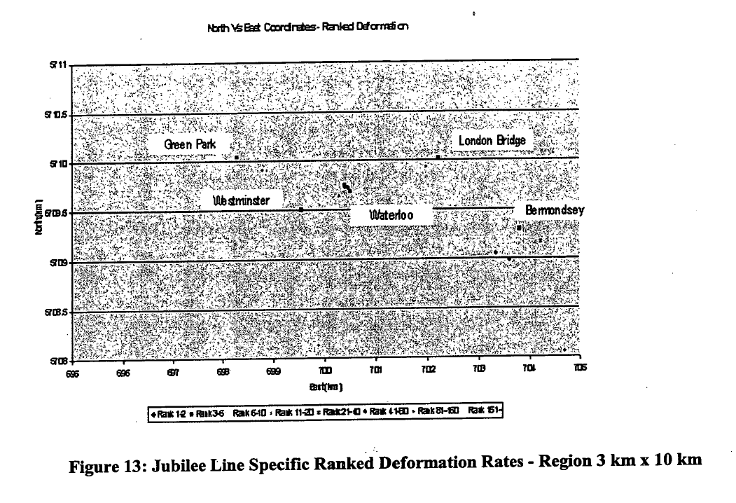

The coherent point scatterer points are geo-coded and their interferometric signatures, including their deviation from the specular average, their deformation relative to a reference frame in time, for each frame, their location, and other information, including, but not limited to, the ratio of the range to azimuth intensity, are stored in a relational database. This database is then used to investigate subsidence and interferometric signatures that have spatial structure, including, but not limited to, tunneling. These points are ranked, as seen in FIG. 11. These ranked clusters are indicative of related deformation. These clusters are then cross-referenced with other geo-spatial databases, resulting in identified structures as seen in FIG. 12 and FIG. 13. FIGS. 12 and 13 show Jubilee Line Extension points, and deformation associated with specific tube stations.

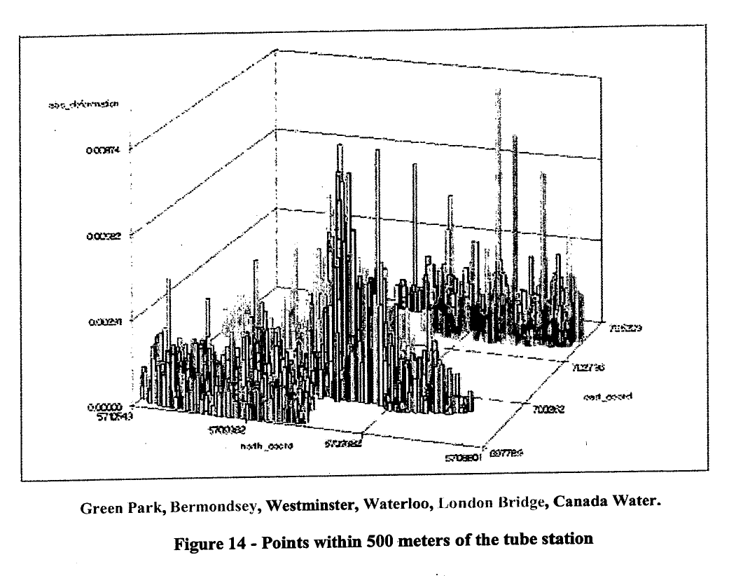

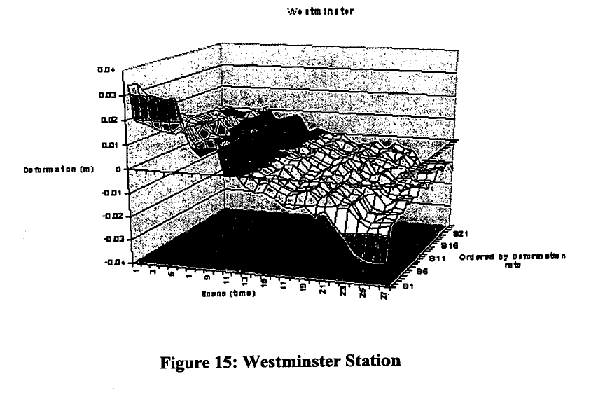

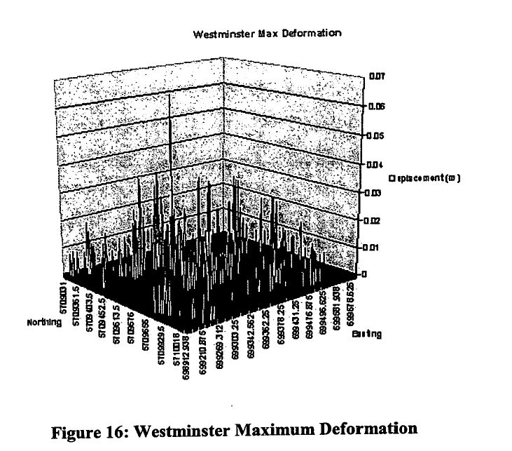

FIG. 14 shows an analysis of points selected from the relational database that are within 500 meters of a fast moving deformation cluster identified with six London Underground Tube stations. One of these stations, Westminster, is shown in FIG. 15 where a three dimensional plot of the 25 fastest moving points within 500 meters of the Westruinister Station are shown with their deformation. This ordered plot exaggerates the vertical deformation as well as the ordering by rate, which isn't by location. However, this accentuates ability to detect and monitor subsidence. Similarly, FIG. 16 takes the same data, but plots it three dimensionally preserving the distance between the points. FIG. 16 accentuates the ability to physically identify the points as they deform.

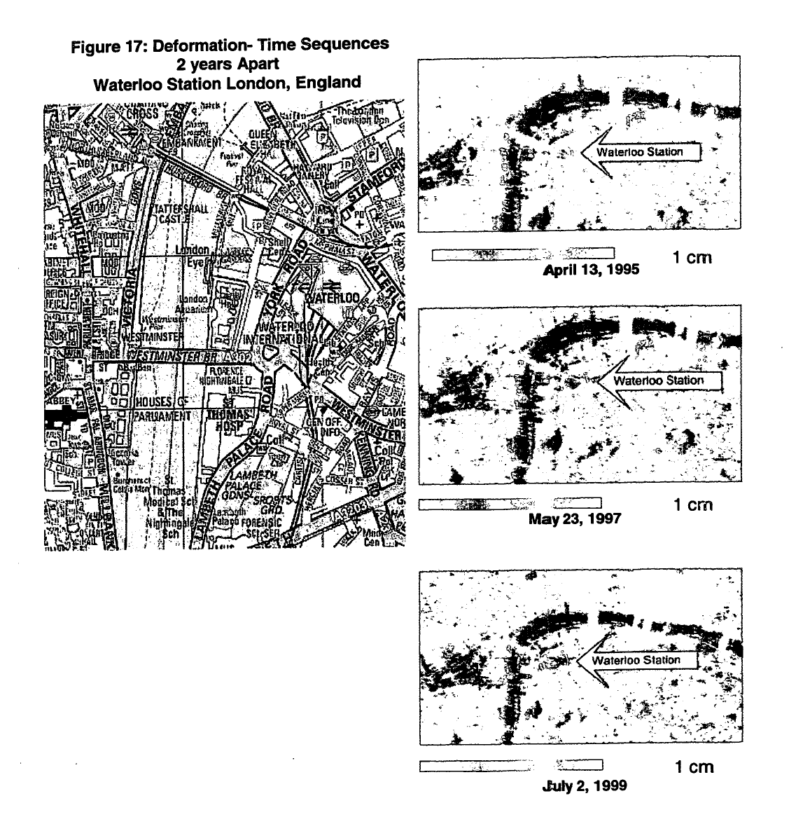

FIG. 17 takes a geo-spatially located point of maximum deformation associated with Waterloo Station, also on the Jubilee Line Extension. A map, derived from the geo-spatial database, sits alongside three deformation maps, each approximately 2 years apart. The sensitivity of Coherent Point Scatterers becomes apparent as even the shape of the building becomes apparent as it slowly sinks due to Jubilee Line Tunneling activity. The building continues to sink even after tunneling ceases, as the ground continues to reach equilibrium.

1. A method for coherence point scatterer bootstrapping, comprising the steps: shown in FIG. 1, of;
inputting data;
generating a coherent point list derived from the input data;
generating point based Single Look Complex data sets;
generating coherent point differential interferograms;
analyzing the interferograms so as to generate models; and,
refining the models by re-evaluating the coherent point interferometric signatures;
